(19) United States
(12) Patent Application Publication
(10) Pub. No.: US 2026/0020517 A1
(43) Pub. Date: Jan. 22, 2026

(54) SEPARATING DEVICE FOR A DISTRIBUTION UNIT AND ASSOCIATED SEEDER

(71) Applicant: KUHN SAS, Saverne (FR)

(72) Inventor: Olivier CONSTANT, Weiterswiller (FR)

(73) Assignee: KUHN SAS, Saverne (FR)

(21) Appl. No.: 19/266,335

(22) Filed: Jul. 11, 2025

(30) Foreign Application Priority Data
Jul. 22, 2024 (FR) FR2408066

(51) Int. Cl. A01C 7/04

(52) U.S. Cl. CPC A01C 7/0445; A01C 7/046

(57) ABSTRACT

A separating device for a distribution unit of granular elements counting a plurality of perforations each including an internal channel with an inlet and an outlet, including an separating wheel including a rotation axis and a peripheral surface, the separating wheel including a plurality of radial projections projecting from the peripheral surface, which are designed to be inserted into the internal channel of one of the perforations in an insertion position, wherein the radial projections are designed to be inserted through the inlet of the internal channel of one of the perforations in a sealing manner inside the internal channel by shape matching and/or by a sealing element in the insertion position so as to achieve sealing inside the internal channel.

### BACKGROUND OF THE INVENTION

### Field of the Invention

The invention relates to the field of separating devices for a distribution unit and to the field of seeders.

The invention thus relates more generally to the field of single-seed seeding, which is also known as precision seeding, i.e. seeding in rows of seeds one by one. Single-seed seeding has applications in maize, beet, soybean and similar crops.

A single-seed seeder generally takes the shape of a backbone chassis on which seeder elements, generally between 4 and 12, or even more, are mounted by a parallelogram. The spacing between these seeder elements varies according to the crop, preferably between 37.5 centimeters and 80 centimeters, but makes it possible to form distinct rows. For this reason, it is common in this case to speak of row crops, as opposed to crops such as wheat where spacing is much closer.

As is known, a distribution device of a single-seed seeder generally functions as follows.

A two-part sealed housing includes a perforated dispensing disc, preferably driven in rotation by a motor, which forms a distribution unit of a plurality of granular elements. The dispensing disc separates the housing into two chambers with different air pressures, creating a positive or negative pressure difference on either side of the perforated dispensing disc. The housing is connected to a blower which allows the pressure difference to be controlled according to the type of seed, speed of advance and other parameters.

At the bottom of the perforated dispensing disc, i.e. at the bottom of the housing, there is a reserve area for granular elements, for example seeds, which is usually supplied by a hopper. These seeds are in contact with the rotating perforated dispensing disc, which, as it rotates, draws the seeds one by one into its perforations.

The diameter and shape of the perforations in the dispensing disc are designed to accommodate a single granular element, for example a seed. The granular element is held in the perforation by the pressure difference between the two sides of the dispensing disc. The perforations are often bordered by special shapes which are, for example, raised and/or recessed and are arranged in the dispensing disc in such a way as to guide and/or direct the seeds towards the perforation. These areas around the perforations are commonly referred to as agitators.

Once the seeds have been dispensed into the perforations of the dispensing disc, a so-called selection system eliminates any excess seeds to avoid duplicates, as several seeds may be lodged in a single perforation, which is not desirable. Selection can be made by teeth, brushes, or similar, which are fixedly mounted and located outside and/or inside the seed path. As a result, excess seeds fall back into the reserve area.

Once the seeds have been selected, they are transported to the last distribution area, which is generally located in the last quarter-turn of the dispensing disc, where the pressure difference is no longer present. As a result, excess seeds fall back into the reserve area. As a result of this lack of pressure difference, the seed is ejected from the perforation and exits the distribution unit towards the ground. Seed ejection can be assisted by a wheel which cuts the pressure difference and, if necessary, pushes the seed out of the perforation using pins, the wheel thus forming a separating device.

### DESCRIPTION OF THE RELATED ART

Publication DE102009043881A1 illustrates such a wheel with a cylindrical base, the top of which is fitted with a pin surrounded by a flat seal.

Publication WO 2022/159027A1 illustrates a wheel with pins and a seal surrounding each pin.

In these publications, the pin is inserted into the perforation with a clearance, while the seal rests against the disc wall at the perforation entrance without penetrating it. In some cases, the pressure difference is not interrupted by the pin, so the seed may not leave the disc due to a less-than-optimal seal.

### SUMMARY OF THE INVENTION

The aim of the present invention is to remedy at least the main drawbacks mentioned above and to provide a solution for improving the efficiency of pressure difference cut-off by optimizing sealing.

To this end, the invention relates to a separating device for a distribution unit of a plurality of granular elements,

the distribution unit being arranged to distribute a plurality of granular elements in a discrete and singular manner and including a plurality of perforations each including an internal channel with an inlet and an outlet, the separating device including at least:

a separating wheel with an axis of rotation and a peripheral surface,

the separating wheel including a plurality of radial projections protruding from the peripheral surface, each of the radial projections being designed for insertion into the internal channel of one of the perforations in an insertion position, the separating device being characterized in that:

the radial projections are designed to be inserted through the inner channel inlet of one of the perforations in a sealing manner inside the inner channel by shape matching and/or by a sealing element in the insertion position to achieve sealing inside the inner channel.

The invention relates to an assembly including a separating device for a distribution unit of a plurality of granular elements and a distribution unit of a plurality of granular elements, the distribution unit being arranged to distribute a plurality of granular elements in a discrete and singular manner and including a plurality of perforations including an internal channel with an inlet and an outlet, characterized in that the separating device is in accordance with the invention.

The invention relates to a seeder including at least the assembly containing a separating device for a distribution unit of a plurality of granular elements and a distribution unit of a plurality of granular elements, characterized in that the assembly is in accordance with the invention.

### BRIEF DESCRIPTION OF THE DRAWINGS

The invention will be better understood from the following description, which refers to several preferred embodiments, given by way of non-limiting examples, and explained with reference to the appended schematic drawings, in which:

FIG. 1 shows a perspective view of an assembly including a separating device and a distribution unit of a plurality of granular elements of a first embodiment alternative according to the invention,

FIG. 2 shows a cross-sectional view of a radial projection of the separating device in an internal channel of one of the perforations of the distribution unit in an insertion position according to the invention of the assembly shown in FIG. 1,

FIG. 3 shows a perspective view of the separating device according to the invention of the assembly shown in FIG. 1,

FIG. 4 shows a cross-sectional view of a radial projection of the separating device according to the invention in the assembly shown in FIG. 1,

FIG. 5 shows a perspective view of the distribution unit of the assembly shown in FIG. 1,

FIG. 6 shows a cross-sectional view of a projection of the separating device in an internal channel of one of the perforations of the distribution unit in an insertion position of an assembly of a second embodiment alternative according to the invention,

FIG. 7 shows a partial perspective view of the assembly of the second embodiment alternative according to the invention,

FIG. 8 shows a partial perspective view of the assembly of the second embodiment alternative according to the invention,

FIG. 9 shows a perspective view of the distribution unit of the assembly shown in FIG. 6,

FIG. 10 shows a perspective view of an assembly including a separating device and a distribution unit of a plurality of granular elements in a third embodiment alternative of the invention,

FIG. 11 shows a perspective view of the separating device according to the invention of the assembly shown in FIG. 10,

FIG. 12 shows a perspective view of an assembly including a separating device and a distribution unit of a plurality of granular elements in a fourth embodiment alternative of the invention,

FIG. 13 shows a perspective view of the separating device according to the invention of the assembly shown in FIG. 12, and

FIG. 14 shows a perspective view of a distribution assembly according to the invention.

### DETAILED DESCRIPTION OF THE PREFERRED EMBODIMENTS

The invention relates to a separating device for a distribution unit 1 of a plurality of granular elements,

the distribution unit 1 being arranged to distribute a plurality of granular elements in a discrete and singular manner and including a plurality of perforations 2 each including an internal channel 3 with an inlet 4 and an outlet 5, the separating device includes at least:
a separating wheel 6 with an axis of rotation 7 and a peripheral surface 8,

the separating wheel 6 having a plurality of radial projections 9 projecting from the peripheral surface 8, each of the radial projections 9 being designed for insertion into the internal channel 3 of one of the perforations 2 in an insertion position P1.

According to the invention, the separating device is characterized in that:

the radial projections 9 are designed to be inserted through the inlet 4 of the internal channel 3 of one of the perforations 2 in a sealed manner inside the internal channel 3 by shape matching and/or by a sealing element 10 in the insertion position P1 to achieve sealing inside the internal channel 3.

Advantageously, this configuration allows an increase in the sealing time of the perforation 2, i.e. the time during which the perforation 2 remains sealed by the radial projection 9. As a result, the present invention allows an improvement in the efficiency of the pressure difference cut-off by optimizing the sealing. This solution has the additional advantages of being suitable for all types of seed and of having no impact on the dimensions of the separating device.

Preferably, each radial projection 9 has the shape of a circular cylinder with a curved profile or a truncated cone and is designed to fit tightly into the complementarily shaped internal channel 3 in the shape of a circular cylinder with a curved profile or a truncated cone by shape matching in the insertion position P1.

Advantageously, this results in the radial projection 9 having a shape that enables the internal channel 3 to be closed over a larger sector in the insertion position P1 than in the known prior art. The profile of the radial projection 9 is therefore optimized to improve sealing.

Preferably, each radial projection 9 includes the sealing element 10 designed to be inserted inside the internal channel 3 of the perforation 2 in the insertion position P1.

Advantageously, the sealing element 10 provides a seal inside the internal channel 3 and compensates for any clearance between the radial projection 9 and the internal channel 3 in the insertion position P1.

Preferably, each radial projection 9 in the shape of a circular cylinder with a curved profile or a truncated cone has a groove 11 and the sealing element 10 is an O-ring fitting into the groove 11.

Preferably, each radial projection 9 in the shape of a circular cylinder with a curved profile or a truncated cone has a preferably flat or domed apex 12 from which a centering pin 13 projects, the centering pin 13 is designed to open towards the outlet 5 of the internal channel 3 of the perforation 2 in the insertion position P1.

Preferably, the groove 11 is located on the profile of each radial projection 9, between the peripheral surface 8 and the apex 12.

Advantageously, the centering pin 13 allows mechanical pushing back of the granular element and avoids its jamming at the outlet 5.

Preferably, the peripheral surface 8 includes at least a first row R1 of radial projections 9 designed to fit into a first circular row C1 of perforations 2.

Advantageously, this possibility is particularly beneficial for a distribution unit 1 with one or more circular rows C1 of perforations 2.

Preferably, the peripheral surface 8 also includes at least one row RD1 of teeth 14 for insertion into a circular row CD1 of preferably blind guiding holes 15.

Advantageously, the at least one row RD1 of teeth 14 ensures continuity of rotation of the separating wheel 6 around the axis of rotation 7. This possibility is particularly advantageous for a distribution unit 1 with a limited number of perforations 2, i.e. less than thirty perforations 2 on the distribution unit 1, for example.

The invention relates to an assembly including a separating device for a distribution unit 1 of a plurality of granular elements and a distribution unit of a plurality of granular elements, the distribution unit being designed to distribute a plurality of granular elements in a discrete and singular manner and counting a plurality of perforations 2 including an internal channel 3 with an inlet 4 and an outlet 5, characterized in that the separating device is in accordance with the invention and as previously described.

The invention relates to a seeder including at least the assembly including a separating device for a distribution unit 1 of a plurality of granular elements and a distribution unit 1 of a plurality of granular elements, characterized in that the assembly is in accordance with the invention as described above.

The distribution unit 1 and the separating device are preferably intended to form part of a distribution assembly 16 which further includes a sealed housing 17 with a fixed part 18 and a movable part in the shape of a door 19.

The distribution unit 1 usually includes a dispensing disc perforated by perforations 2, preferably driven in rotation by a motor on a drive axis 20.

The dispensing disc separates the housing 17 into two chambers, the first chamber and the second chamber, in which the air pressures are preferably different. The first and second chambers are preferably substantially cylindrical in shape. The door 19 preferably receives the dispensing disc, but this example is not limiting. The first chamber can receive all or part of the plurality of granular elements and the second chamber is closed by the door 19 at least in its closed position.

The perforations 2 are preferably arranged circularly along one or more circular rows C1, C2 and are spaced from one another. The perforations 2 are through-holes.

Preferably, the first circular row C1 includes sixty perforations 2.

Preferably, the second circular row C2 includes sixty perforations 2.

The internal channel 3 creates communication between the first chamber and the second chamber.

The inlet 4 allows insertion of radial projection 9 and is designed to open into the second chamber.

The outlet 5 is designed to be in contact with a granular element and is intended to open into the first chamber.

The inlet 4 preferably has a larger diameter than the outlet 5.

The inlet 4 may also include a radial lip 22 to further reduce the diameter of the outlet 5. However, the reduced diameter allows the centering pin 13 to be inserted in the insertion position P1.

Preferably, the radial lip 22 is in contact with the apex 12 at least partially in the insertion position P1.

The separating wheel 6 is preferably mounted so as to rotate around the axis of rotation 7 on a support 21 which is attached to the drive axis 20.

The axis of rotation 7 and the drive axis 20 are preferably secant.

The separating wheel 6 preferably has a smaller diameter than the diameter of the dispensing disc.

The peripheral surface 8 has a width substantially identical to the width of the at least one circular row C1, C2.

Each radial projection 9 preferably has an axis of revolution which extends in a radial direction of the separating wheel 6.

The radial projections 9 are preferably distributed along at least one row R1 on the peripheral surface 8.

The radial projections 9 are preferably distributed in a first row R1 and a second adjacent row R2 on the peripheral surface 8.

In this case, preferably the radial projections 9 of the first row R1 and the second row R2 are not aligned side by side but are offset.

The height of each radial projection 9 is preferably between 5 millimeters and 40 millimeters.

Each radial projection 9 has a matching shape to that of the internal channel 3, so that in the inserted position, radial projection 9 and internal channel 3 fit together with or without clearance. If there is clearance, the sealing element 10 can compensate for it.

The separating wheel 6 preferably has nine radial projections 9.

The sealing element 10 is preferably made of an elastomer-type material and has an external diameter of between 7 and 15 millimeters, and a thickness of between 2 and 6 millimeters.

The sealing element 10 may be an O-ring, for example.

The groove 11 preferably has a depth and height of between 2 millimeters and 5 millimeters.

The centering pin 13 is preferably in the shape of a pin or stud.

The centering pin 13 preferably has an external diameter of between 2 millimeters and 10 millimeters, and a height of between 1 millimeter and 5 millimeters.

The teeth 14 are preferably distributed along a row RD1 adjacent to the first row R1 of radial projections 9.

Preferably, the radial projections 9 of the first row R1 and the teeth 14 of the row RD1 are not aligned side by side but are offset.

The separating wheel 6 preferably has six teeth 14.

Each tooth 14 has, for example, the shape of a parallelepiped.

The guiding holes 15 are preferably arranged circularly along a circular row CD1.

Preferably, the circular row CD1 includes twenty-one guiding holes 15.

The guiding holes 15 are preferably through-holes or blind holes.

Each tooth 14 has a matching shape to each guiding hole 15 to allow insertion of the teeth 14 into the guiding holes 15.

The radial lip 22 extends radially in the diameter of outlet 5 over a length I and has a thickness e.

The radial lip 22 can preferably have a beveled and/or rounded and/or flat free edge 23.

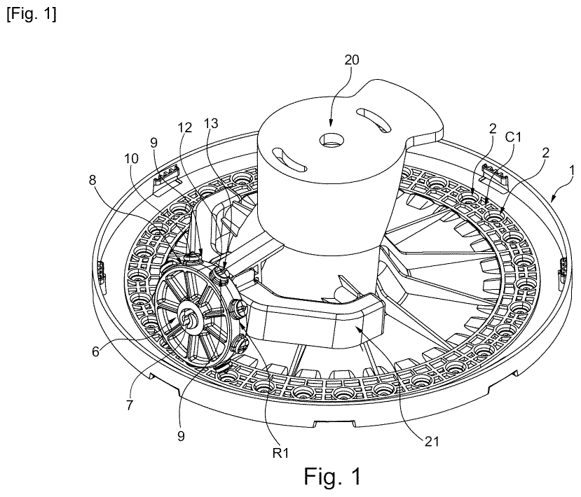

FIGS. 1 to 5 show a first embodiment alternative of the assembly according to the invention.

FIG. 1 shows the assembly according to the invention in the first embodiment alternative, with the separating device including the separating wheel 6 and the distribution unit 1 in the shape of a dispensing disc. In this example, the separating wheel 6 is mounted in rotation by the rotation axis 7 on the support 21, the latter being fixed to the drive axis 20. The peripheral surface 8 of the separating wheel 6 includes a single first row R1 of radial projections 9. Each radial projection 9 has the shape of a truncated cone and includes a sealing element 10 in the shape of an O-ring. A centering pin 13 projects from the apex 12 of the truncated cone. The centering pin 13 is aligned with the axis of revolution of the truncated cone. The distribution unit 1 in the shape of the dispensing disc has a single first circular row C1 of perforations 2.

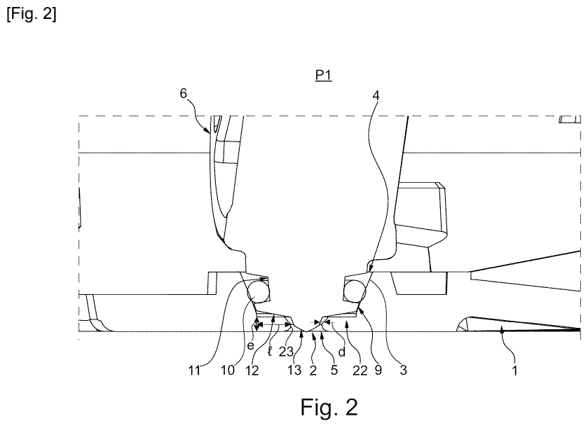

FIG. 2 shows in detail the insertion of a radial projection 9 of the separating wheel into the internal channel 3 of a perforation 2 of the distribution unit 1, this position corresponding to the insertion position P1. This figure shows in particular that the sealing element 10 in the shape of an O-ring is inserted into the groove 11. In addition, the apex 12 has a domed shape and includes the centering pin 13. The internal channel 3 has a flared truncated-cone shape. The inlet 4 has a larger diameter than the outlet 5, which is fitted with the radial lip 22. This radial lip 22 is opposite or even in contact with the domed surface of the apex 12. In addition, the radial lip 22 surrounds the centering pin 13 positioned at outlet 5. The distance d between the radial lip 22 and the centering pin 13 is preferably between 0 and 1.5 millimeters. In this insertion position P1, the radial projection 9 is fitted into the internal channel 3 through the inlet 4 with a clearance that is compensated for by the sealing element 10, which is arranged inside the internal channel 3 and comes into contact with the internal channel 3 to seal it.

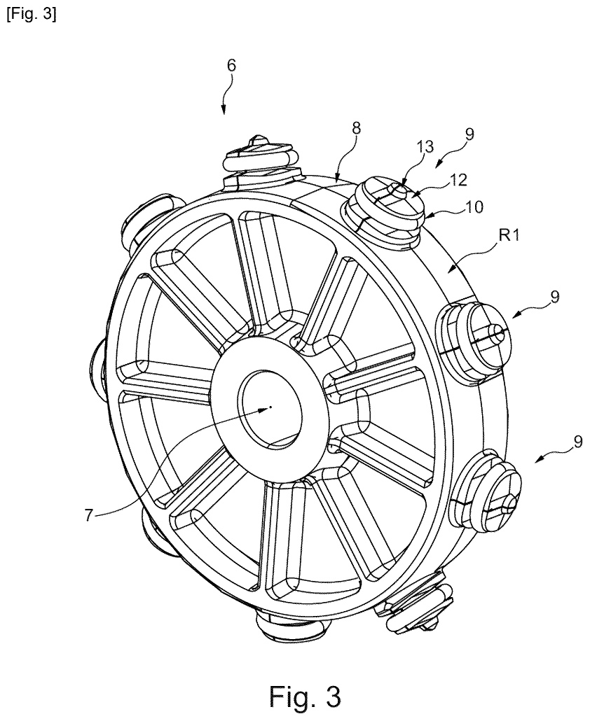

FIG. 3 shows the separating wheel 6 of the separating device rotating around its axis of rotation 7. The peripheral surface 8 of the separating wheel 6 includes a single first row R1 of radial projections 9. Each radial projection 9 has the shape of a truncated cone and includes a sealing element 10 in the shape of an O-ring. A centering pin 13 projects from the apex 12 of the truncated cone. The centering pin 13 is aligned with the axis of revolution of the truncated cone.

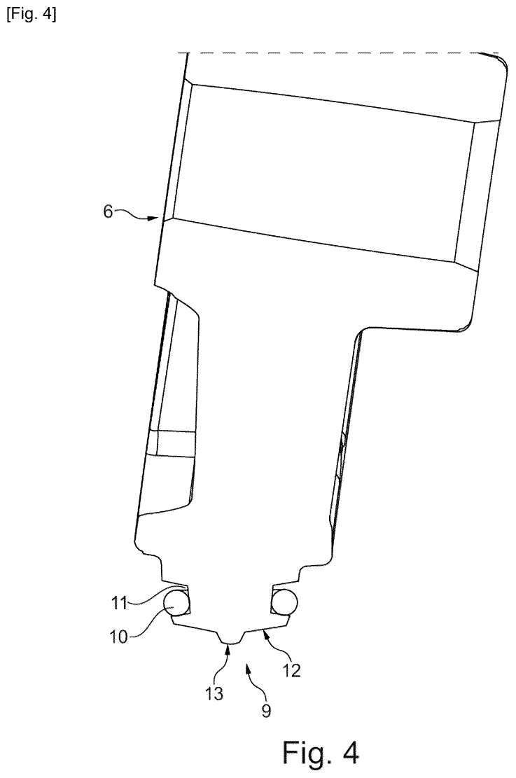

FIG. 4 shows a radial projection 9 of the separating wheel 6, which has the shape of a truncated cone and includes a sealing element 10 in the shape of an O-ring inserted in the groove 11. The centering pin 13 projects from the apex 12 of the truncated cone, which has a domed surface. The centering pin 13 is aligned with the axis of revolution of the truncated cone.

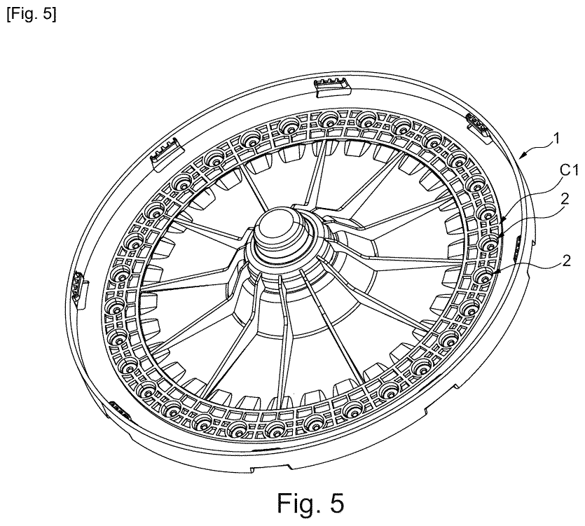

FIG. 5 shows the distribution unit 1 in the shape of a dispensing disc with a single first circular row C1 of perforations 2.

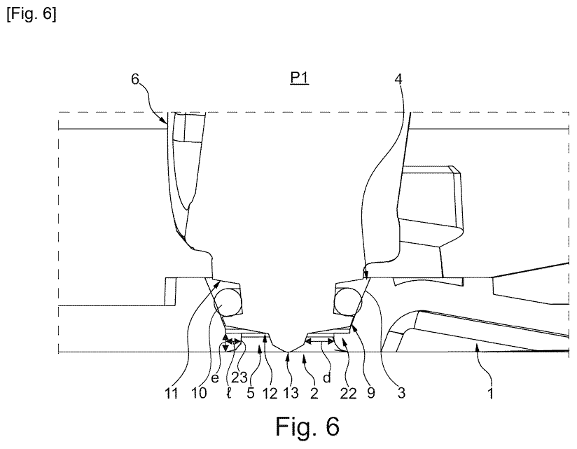

FIGS. 6 to 9 show a second embodiment alternative of the assembly according to the invention. In this alternative, the separating wheel 6 is identical to that of the first alternative, the only difference being the shape of the distribution unit 1, in particular the perforations 2.

FIG. 6 shows in detail the insertion of a radial projection 9 of the separating wheel 6 into the internal channel 3 of a perforation 2 of the distribution unit 1, this position corresponding to the insertion position P1. Similar to FIG. 2, the sealing element 10 in the shape of an O-ring is inserted into the groove 11 and the apex 12 has a domed shape and includes the centering pin 13. The internal channel 3 has the flared shape of a truncated cone. Inlet 4 has a larger diameter than outlet 5, which is fitted with radial lip 22. This radial lip 22 is opposite but not in contact with the convex surface of the apex 12. In addition, the radial lip 22 surrounding the centering pin 13 extends less in the radial direction than in the example of the first embodiment alternative shown in particular in FIG. 2. Indeed, the radial lip 22 has a shorter length I than the radial lip 22 of FIG. 2. The distance d between the radial lip 22 and the centering pin 13 is preferably between 1 millimeter and 5 millimeters. In this insertion position P1, the radial projection 9 is inserted into the internal channel 3 through the inlet 4 with a clearance that is compensated for by the sealing element 10, which is arranged inside the internal channel 3 and comes into contact with the internal channel 3 to seal it.

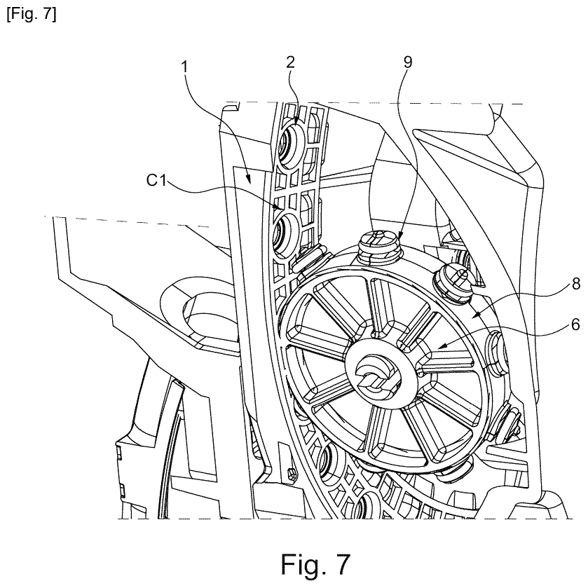

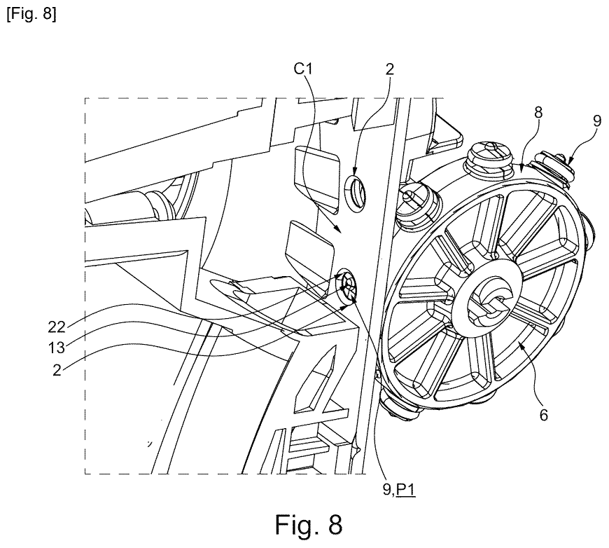

FIGS. 7 and 8 partially show the assembly according to the invention in the second embodiment alternative with the separating device including the separation wheel 6 identical to that of the first embodiment alternative and the distribution unit 1 in the shape of a dispensing disc which is different as detailed in FIG. 6. Each radial projection 9 has the shape of a truncated cone. The distribution unit 1 in the shape of the dispensing disc has a single first circular row C1 of perforations 2.

As shown in FIG. 8, in the insertion position P1, the centering pin 13 is inside the perforation 2 and the radial lip 22 is around the centering pin 13 but at a distance from it.

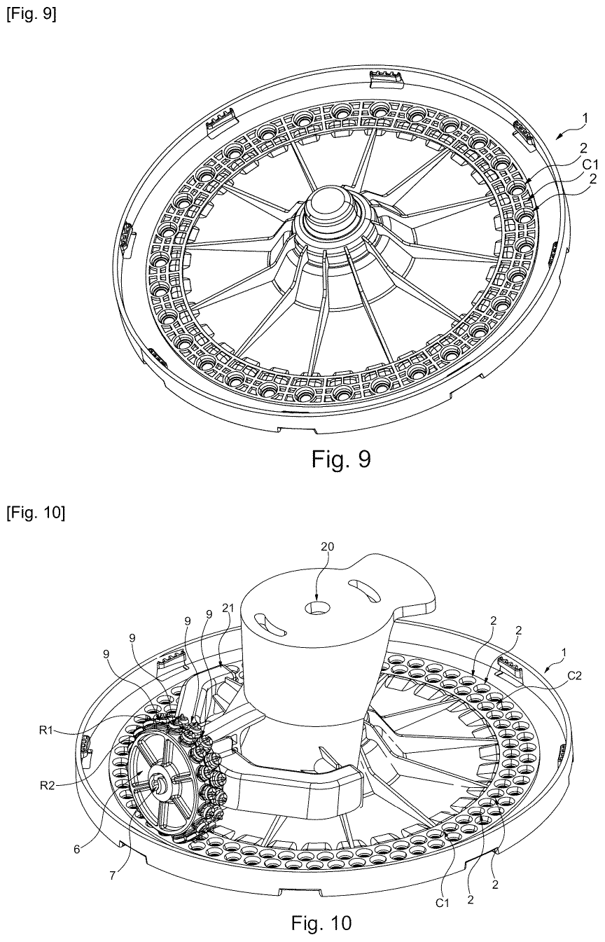

FIG. 9 shows the distribution unit 1 in the shape of a dispensing disc with a single first circular row C1 of perforations 2.

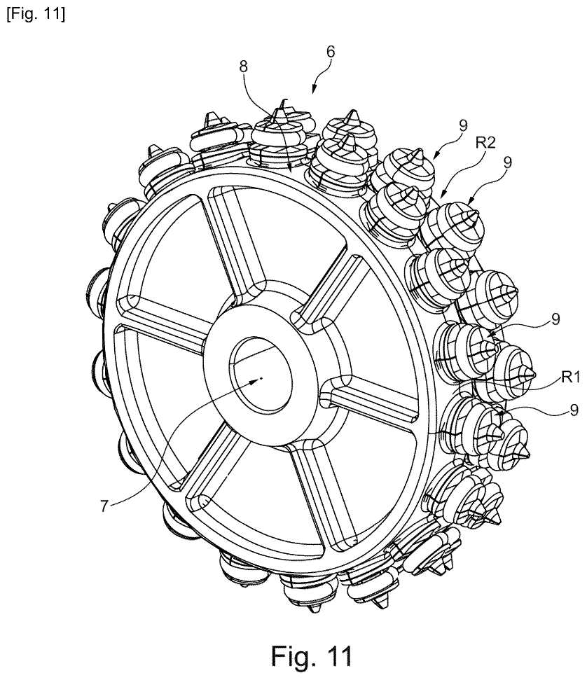

FIGS. 10 to 11 show a third embodiment alternative of the assembly according to the invention.

FIG. 10 shows the assembly according to the invention in the third embodiment alternative, with the separating device including the separating wheel 6 and the distribution unit 1 in the shape of a dispensing disc. In this example, the separating wheel 6 is mounted in rotation by the rotation axis 7 on the support 21, the latter being fixed to the drive axis 20. The peripheral surface 8 of the separating wheel 6 includes a first row R1 of radial projections 9 and a second row R2 of radial projections 9. Each radial projection 9 has features identical to those of the first and second alternatives described above. The distribution unit 1 in the shape of the dispensing disc has a first circular row C1 of perforations 2 and a second circular row C2 of perforations 2.

FIG. 11 shows the separating wheel 6 of the separating device rotating around its axis of rotation 7. The peripheral surface 8 of the separating wheel 6 includes a first row R1 of radial projections 9 and a second row R2 of radial projections 9. Each radial projection 9 has features identical to those of the first and second alternatives described above. The radial projections 9 of the first row R1 and the second row R2 are not aligned side by side but are offset.

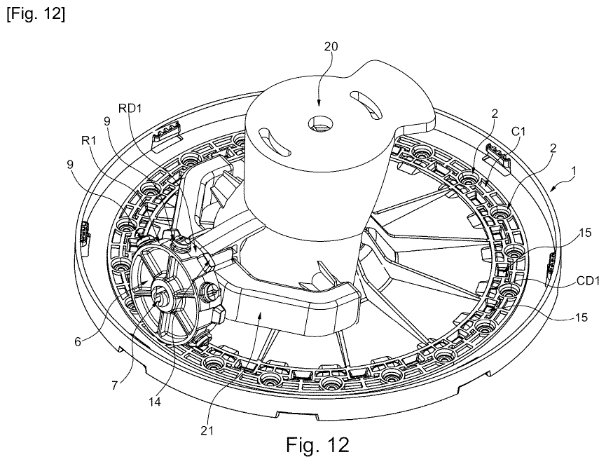

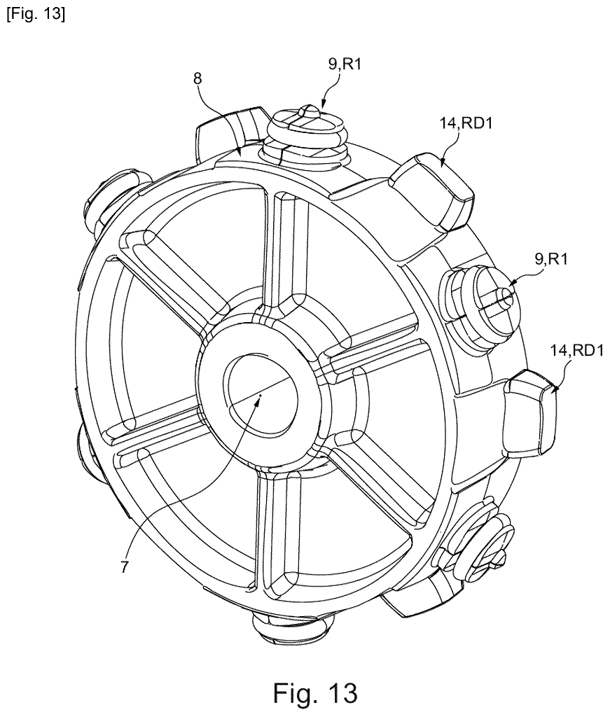

FIGS. 12 to 13 show a fourth embodiment alternative of the assembly according to the invention.

FIG. 12 shows the assembly according to the invention in the fourth embodiment alternative, with the separating device including the separating wheel 6 and the distribution unit 1 in the shape of a dispensing disc. In this example, the separating wheel 6 is mounted in rotation by the rotation axis 7 on the support 21, the latter being fixed to the drive axis 20. The peripheral surface 8 of the separating wheel 6 includes a single first row R1 of radial projections 9 and a row RD1 of teeth 14. Each radial projection 9 has the same features as the first, second and third alternatives described above. The distribution unit 1 in the shape of the dispensing disc has a first circular row C1 of perforations 2 and a circular row CD of guiding holes 15. The perforations 2 have identical features to those of the first alternative. The guiding holes 15 are blind. The first circular row C1 is located closer to the edge than the circular row CD of guiding holes 15.

FIG. 13 shows the separating wheel 6 of the separating device rotating around its axis of rotation 7. The peripheral surface 8 of the separating wheel 6 includes a single first row R1 of radial projections 9 and a row RD1 of teeth 14. Each radial projection 9 has features identical to those of the first and second alternatives described above. The radial projections 9 of the first row R1 and the teeth 14 of the row RD1 are not aligned side by side but are offset.

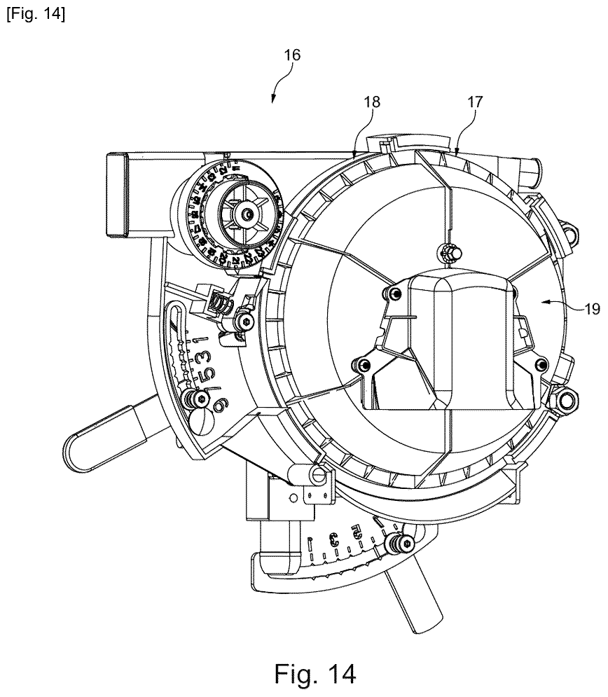

FIG. 14 shows a distribution assembly 16 including a sealed housing 17 with the fixed part 18 and the door 19. The distribution unit 1 and the separating device, which are not visible, are located inside the housing 17.

Of course, the invention is not limited to the embodiments described and shown in the appended drawings. Modifications remain possible, particularly in terms of the constitution of the various elements or by substituting technical equivalents, without however leaving the field of protection of the invention.

1. A separating device for a distribution unit of a plurality of granular elements,
the distribution unit being arranged to distribute a plurality of granular elements in a discrete and singular manner and including a plurality of perforations each including an internal channel with an inlet and an outlet,
the separating device including at least:
a separating wheel including an axis of rotation and a peripheral surface,
the separating wheel including a plurality of radial projections protruding from the peripheral surface, each of the radial projections being designed for insertion into the internal channel of one of the perforations in an insertion position,
wherein:
the radial projections are designed to be inserted through the inner channel inlet of one of the perforations in a sealing manner inside the inner channel by shape matching and/or by a sealing element in the insertion position to achieve sealing inside the inner channel.

2. The separating device according to claim 1, wherein each radial projection has the shape of a circular cylinder with a curved profile or a truncated cone and is designed to fit tightly into the complementarily shaped internal channel in the shape of a circular cylinder with a curved profile or a truncated cone by shape matching in the insertion position.

3. The separating device according to claim 1, wherein each radial projection includes a sealing element designed to be inserted inside the internal channel of the perforation in the insertion position.

4. The separating device according to claim 2, wherein each radial projection includes a sealing element designed to be inserted inside the internal channel of the perforation in the insertion position, and wherein each radial projection in the shape of a circular cylinder with a curved profile or a truncated cone has a groove and in that the sealing element is an O-ring fitting into the groove.

5. The separating device according to claim 2, wherein each radial projection in the shape of a circular cylinder with a curved profile or a truncated cone has a preferably flat or domed apex from which a centering pin projects, the centering pin being designed to open towards the outlet of the internal channel of the perforation in the insertion position.

6. The separating device according to claim 1, wherein the peripheral surface includes at least a first row of radial projections designed to fit into a first circular row of perforations.

7. The separating device according to claim 6, wherein the peripheral surface also includes at least one row of teeth for insertion into a circular row of preferably blind guiding holes.

8. An assembly including a separating device for a distribution unit of a plurality of granular elements and a distribution unit of a plurality of granular elements, the distribution unit being designed to distribute a plurality of granular elements in a discrete and singular manner and counting a plurality of perforations including an internal channel with an inlet and an outlet, wherein the separating device is according to claim 1.

9. A seeder including at least the assembly including a separating device for a distribution unit of a plurality of granular elements and a distribution unit of a plurality of granular elements, wherein the assembly is according to claim 8.
